(19) United States
(12) Patent Application Publication
(10) Pub. No.: US 2006/0114573 A1
(43) Pub. Date: Jun. 1, 2006

(54) Optical element for use in eye protection devices and methods for its manufacture

(76) Inventors: Giuseppe Iori, Reggio Emilia (IT); Graziano Marusi, Parma (IT); Paolo Baiocchi, Parma (IT)

Correspondence Address: STROOCK & STROOCK & LAVAN LLP, 180 MAIDEN LANE, NEW YORK, NY, 10038, US

(21) Appl. No.: 11/090,540

(22) Filed: Mar. 25, 2005

Related U.S. Application Data
(60) Provisional application No. 60/556,261, filed on Mar. 25, 2004.

(51) Int. Cl. G02B 25/00

(52) U.S. Cl. 359/643

(57) ABSTRACT

An optical element is described comprising an optical part dyed so as to have a curve of the factor of spectral transmittance in a wavelength range comprised between 400 and 700 nm comprising: i) at least one relative maximum at a wavelength comprised between 400 and 510 nm, and ii) at least one relative minimum at a wavelength comprised between 510 and 625 nm, wherein the ratio between the value of the factor of spectral transmittance at said at least one relative maximum and the value of the factor of spectral transmittance at said at least one relative minimum is of at least 1.3, and wherein the ratio between the value of the factor of spectral transmittance at a wavelength of 700 nm and the value of the factor of spectral transmittance at said at least one relative minimum is of at least 3.0. Advantageously, such an optical element allows to enhance visual acuity, increasing in particular the chromatic contrast and the sensitivity to the red and blue colors, and to meet the traffic lights and road signal recognition requirements indicated by the international standards.

### FIELD OF THE INVENTION

In a general aspect thereof, the present invention relates to an optical element for use in eye protection devices such as for example eyeglasses, masks, visors and the like.

More particularly, the invention relates to an optical element adapted to be used as a lens for sunglasses, mask or visor and capable of considerably enhancing the color contrast perception of the wearer.

The optical element of the invention may be either a semi-finished product from which it is possible to obtain by forming and possibly by beveling an ocular for eye protection devices, such as for instance a lens of any shape for eyeglasses, or a finished product, such as for instance an ocular in the form of a lens for sunglasses, visors, protection masks or portable screens.

In the following description and in the appended claims, the terms: eye protection device, and: ocular, are used to indicate elements suitable respectively to protect the eyes and to allow the vision, as defined by European Standard CEN EN 165.

### BACKGROUND OF THE INVENTION

As is known, the sun gives off electromagnetic radiation formed by photons which oscillate at wavelengths inversely related to their energy. Thus, a photon oscillating at a low wavelength will have an energy higher than the energy of a photon oscillating at a higher wavelength.

The human eye reacts to the different wavelengths of the solar light and converts these wavelengths into electrical signals that the brain elaborates to give the various sensations of color. The wavelength range that the human eye can detect is generally called the visible spectrum and ranges from about 380 to about 780 nanometers (nm).

The following Table 1 shows the correspondence between the wavelengths of the various spectral bands of the solar radiation and the color of the corresponding luminous sensation perceived by the human eye.

TABLE 1

| Color Sensation | Wavelength (nm) |
|---|---|
| Violet | 380 to 424 |
| Blue | 424 to 491 |
| Green | 491 to 575 |
| Yellow | 575 to 585 |
| Orange | 585 to 647 |
| Red | 647 to 780 |

These colors are detected on the retina by color receptors, called “cones”, which are sensitive to color and light. There are three different types of cones having rather wide sensitivity curves which are partially overlapping with each other.

Blue-sensitive cones detect colors ranging from violet to blue and have a maximum sensitivity between 440 and 445 nm. Green-sensitive cones detect colors ranging from green to yellow and have a maximum sensitivity between 535 and 540 nm. Red-sensitive cones have a maximum sensitivity between 570 and 575 nm and detect colors ranging from orange to red. Light and color sensation depends on the degree of stimulation of the three types of cones exerted by the luminous energy which reaches the same. When the various light spectral bands are all equally reflected by a surface, the three types of cones are uniformly stimulated and the eye/brain system perceives the surface as white or black according to the reflection characteristics of the surface. On the contrary, if the light reflected has unbalanced spectral bands, the three types of cones are excited to different extents and the surface appears to be colored. When a dyed optical element is placed between an object and the eye, it attenuates the light intensity and influences the stimulation of the cones. If the curve of spectral transmittance of the optical element is balanced, the result is a simple reduction of the transmitted light along the entire wavelength range with a substantially unchanged color sensation.

Within the framework of the optical elements for daily use, a particularly important parameter is visual acuity, intended as the capability of the human eye to discriminate between very small and very close objects. This parameter depends on the chromatic contrast and on the luminance contrast which depends in turn on the lighting system, lighting angle and on the amount of the surrounding reflected light.

Visual acuity is especially important when driving a vehicle, up to the point that one of the requirements which the optical elements put on the market must fulfill is that of allowing a correct perception of the other moving vehicles, of the obstacles, of the traffic lights and signals. In fact, the driver must be capable to see the road signals and the traffic lights even in critical conditions, such as in the case of glare and at low light conditions caused by weather and time of day.

The international standards specify the requirements for a proper color recognition of traffic lights and road signals when viewed through a dyed optical element. For example, the European Standards introduce an attenuation coefficient (Q quotient) for each of the three signal colors: Red, Yellow and Green and for the Blue color of emergency flashing lights. The Q quotient is the ratio between the luminous transmittance of a dyed lens for the spectral radiant power distribution of the light emitted by a traffic signal t_{sign} and the transmittance of the same lens for the standard illuminant D 65. The standard illuminant D 65 represents in turn medium daylight conditions with the color temperature of 6500 K and is usually generated by the use of xenon lamps with filters.

According to European Standard EN 1836:1997, the Q quotient cannot be less than 0.8 for red and yellow signals, not less than 0.40 for the blue signal and not less than 0.6 for the green signal; this means for example that the visibility through the optical element of the traffic lights must be not less than 80% of the visibility of the standard daylight (D65) for red and yellow colors, not less than 40% of the visibility of the standard daylight for the blue color and not less than 60% of the visibility of the standard daylight for the green color. A Q quotient of a lens greater than 1 for a particular color signal therefore implies that such color is less attenuated than the standard daylight so that the lens contributes to enhance the visibility of such a signal.

### PRIOR ART

In view of the fact that conventional optical elements, such as for example sunglass lenses or ski masks, inevitably provide to the wearer an attenuated or modified light perception, many attempts have been made to develop optical elements which enhance visual acuity for example by increasing chromatic contrast.

Thus, for example, U.S. Pat. Nos. 6,334,680 and 6,145,984 suggest to this end to use glass lenses with a transmission curve having a series of maxima and minima obtained by using rare earth oxides, such as neodymium, praseodymium and erbium oxides, while U.S. Pat. No. 5,400,175 suggests to use dyes which primarily absorb blue light.

The aforementioned optical elements of known type, however, can distort color vision and as such be unable to meet the traffic lights color recognition requirements indicated in the international standards (European Standard EN1836:1997 and/or US standard ANSI Z 80.3) and therefore can be unsuitable for use when driving.

In particular, the strong light absorption of neodymium oxide at 589 nm, corresponding to the main wavelength of sodium lights used in road tunnels and to the wavelength of the LEDs commonly used in highway warning signs, can significantly compromise visibility in the tunnels and the recognition of road signals when driving.

### SUMMARY OF THE INVENTION

One object of the present invention is therefore that of providing an optical element which is capable of enhancing visual acuity, increasing in particular the sensitivity to the red and blue colors, while being capable at the same time to fulfill the stringent recognition requirements of the traffic lights and road signals indicated by the international standards.

According to the present invention, it has been found that it is possible to achieve this and further objects which will be better apparent in the following, and to overcome the drawbacks of the optical elements manufactured according to the cited prior art, by means of a special dyeing of the optical element which allows to enhance visual acuity by increasing the color contrast perception, or chromatic contrast.

According to a first aspect thereof, the present invention therefore provides an optical element as defined in attached claim 1.

According to the invention, it has in particular been found that the desired effect of an enhanced perception of chromatic contrast and thus of the visual acuity, may be effectively achieved by dyeing the optical part of the optical element so as to have a curve of the factor of spectral transmittance in a wavelength range comprised between 400 and 700 nm comprising:
i) at least one relative maximum at a wavelength comprised between 400 and 510 nm, and
ii) at least one relative minimum at a wavelength comprised between 510 and 625 nm,
   wherein the ratio between the value of the factor of spectral transmittance at said at least one relative maximum and the value of the factor of spectral transmittance at said at least one relative minimum is of at least 1.3, and
   wherein the ratio between the value of the factor of spectral transmittance at a wavelength of 700 nm and the value of the factor of spectral transmittance at said at least one relative minimum is of at least 3.0.

Thanks to this combination of features and as will be better apparent in the following, it is advantageously possible to exploit the high sensitivity of the human eye to radiation having a wavelength around 550 nm, so that a reduction of the light amount within a relatively ample range about this wavelength will not significantly reduce the visibility of the corresponding colors (green-yellow), since the eye-brain receptive system is capable to adapt itself to this reduced energy.

Conversely, the increase of the factor of spectral transmittance in a wavelength range comprised between 400 and 510 nm and between 625 and 700, where the eye is less sensitive, is capable to amplify the corresponding colors (blue-green and orange-red) since the corresponding luminous energy is higher than that in the wavelength range wherein the eye sensitivity is at its maximum.

In particular, this technical effect is achieved thanks to a proper value of the ratio between the value of the factor of spectral transmittance at said at least one relative maximum and the value of the factor of spectral transmittance at said at least one relative minimum and of the ratio between the value of the factor of spectral transmittance at a wavelength of 700 nm and the value of the factor of spectral transmittance at said at least one relative minimum.

In the following description and in the appended claims, the term: factor of spectral transmittance or T, is used to indicate the percent ratio, for a given wavelength (λ), of the spectral radiant flux transmitted by the optical element to the incident spectral radiant flux, according to European Standard CEN EN 165 point 2.123.

In the following description and in the appended claims, furthermore, all numbers expressing amounts, quantities, percentages, and so forth, are to be understood as being modified in all instances by the term “about” except where otherwise indicated. Also, all the ranges of numerical quantities include all the possible combinations of the maximum and minimum values and all the possible intermediate ranges, in addition to those specifically indicated in the following.

Preferably, the curve of the factor of spectral transmittance of the optical part of the optical element according to the invention comprises at least one relative maximum at a wavelength comprised between 440 and 500 nm.

In this way, it is advantageously possible to increase in an optimal way the perception of the chromatic contrast by increasing the light transmitted in one of the wavelength ranges wherein the human eye is less sensitive (blue-green).

Preferably, the curve of the factor of spectral transmittance of the optical part of the optical element according to the invention comprises at least one relative minimum at a wavelength comprised between 540 and 610 nm.

Thanks to this feature, it is advantageously possible to increase in an optimal way the perception of the chromatic contrast by reducing the light transmitted in the wavelength range wherein the human eye is most sensitive without reducing at the same time the visibility of the corresponding colors (green-yellow) thanks to the adaptation capabilities of the eye-brain receptive system.

In a preferred embodiment and in order to fully exploit the aforementioned advantageous technical effect, the curve of the factor of spectral transmittance of the optical part comprises at least one relative minimum at a wavelength comprised between 560 and 600 nm.

Preferably, the value of the factor of spectral transmittance at said at least one relative maximum is comprised between 4% and 40% and, still more preferably, comprised between 5% and 15%.

In this way, it is advantageously possible to obtain the maximum enhancement effect of the chromatic contrast perception by increasing the light transmitted in one of the wavelength ranges wherein the human eye is less sensitive (blue-green).

Preferably, the value of the factor of spectral transmittance at said at least one relative minimum is comprised between 2% and 40% and, still more preferably, comprised between 5% and 20%.

In this way, it is advantageously possible to have a correct and adequate perception of the light transmitted in the wavelength range wherein the human eye is most sensitive (green-yellow) thanks to the adaptation capability of the eye-brain receptive system.

In a preferred embodiment, the ratio between the value of the factor of spectral transmittance at said at least one relative maximum and the value of the factor of spectral transmittance at said at least one relative minimum is comprised between 1.3 and 15 and, still more preferably, between 2 and 10.

In this way, it is advantageously possible to optimize the enhancement effect of the chromatic contrast perception by suitably increasing the light transmitted in one of the wavelength ranges wherein the human eye is less sensitive (blue-green) with respect to the light transmitted in the wavelength range wherein the human eye is most sensitive (green-yellow).

In a preferred embodiment, the ratio between the value of the factor of spectral transmittance at a wavelength of 700 nm and the value of the factor of spectral transmittance at said at least one relative minimum is comprised between 3.0 and 20 and, still more preferably, between 5 and 15.

In this way, it is advantageously possible to optimize the enhancement effect of the chromatic contrast perception by suitably increasing the light transmitted in one of the wavelength ranges wherein the human eye is less sensitive (orange-red) with respect to the light transmitted in the wavelength range wherein the human eye is most sensitive (green-yellow).

In a preferred embodiment and in order to ensure and adequate perception of the chromatic contrast in the wavelength range comprised between 400 and 625 nm and, more preferably, between 440 and 610 nm, the difference between the value of the factor of spectral transmittance at said at least one relative maximum and the value of the factor of spectral transmittance at said at least one relative minimum is comprised between 2% and 50%.

Still more preferably, such a difference is comprised between 5% and 30%.

In a preferred embodiment and in order to ensure and adequate perception of the colors in the red range, which is of particular importance in the vision of the traffic lights and of warning signals when driving a vehicle, the value of the factor of spectral transmittance at a wavelength of 700 nm is equal to at least 20% and, more preferably, equal to at least 30%.

Still more preferably, the value of the factor of spectral transmittance at a wavelength of 700 nm is comprised between 30% and 90%.

In a preferred embodiment, the factor of spectral transmittance in a wavelength range comprised between 625 and 700 nm has an increasing value as the wavelength increases.

In this way, it is advantageously possible to optimize the effect of an enhanced perception of the chromatic contrast by increasing the light transmitted in one of the wavelength ranges wherein the human eye is less sensitive (orange-red).

In a preferred embodiment and in order to ensure and adequate perception of the colors in the wavelength range wherein the human eye is most sensitive (green-yellow), the value of the factor of spectral transmittance in a wavelength range comprised between 480 and 510 nm is equal to at least 10%.

Still more preferably, the value of the factor of spectral transmittance in a wavelength range comprised between 480 and 510 nm is comprised between 10% and 20%.

Preferably, the value of the factor of spectral transmittance at a wavelength equal to or lower than 400 nm is substantially equal to 0%.

In this way, it is advantageously possible to prevent that the harmful ultraviolet radiations could reach the eye.

For the purposes of the invention, the optical element is preferably essentially constituted by a substrate made of transparent plastics material.

Plastics materials of more preferred and advantageous use are those commonly employed in the optical field, such as: polymethyl methacrylate, polyol-allyl-carbonates, aromatic polycarbonates, polystyrene, cellulose esters, polyacrylates, polyalkylacrylates, polyurethanes, saturated and unsaturated polyesters, transparent polyamides, as well as copolymers and mixtures thereof.

Preferably, the desired chromatic characteristics of the optical part of the optical element of the invention, are achieved by incorporating into the optical part or, alternatively, by incorporating into a protective film applied on the optical part, at least one dyeing substance adapted to suitably filter the visible light.

In a preferred embodiment, the aforementioned at least one dyeing substance is Disperse Violet 1, which has a chemical formula C₁₄H₁₀N₂O₂ (as documented by the Color Index). Disperse Violet 1 is an anthraquinone dye having an absorption peak or, in other words, a relative minimum in the curve of the factor of spectral transmittance in the wavelength range comprised between 540 and 600 nm.

The use of Disperse Violet 1 advantageously allows to absorb the light in a wavelength range comprised between 540 and 600 nm enhancing the perception of the remaining colors, i.e. blue-green and red-orange.

Examples of suitable dyeing substances for the purposes of the invention are the disperse and soluble dyes as described in the Color Index III Edition (Society of Dyers and Colorists, PO Box 244, Perkin House, 82 Grattan Road, Bradford BD1 2JB, England).

Preferably, the aforementioned at least one dyeing substance comprises azobenzene and/or anthraquinone chromophore groups as defined in the Color Index.

For the purposes of the invention and as will be better apparent in the following, the incorporation of the dyeing substance or substances in the optical part or in the aforementioned protective film may be carried out by immersing the optical part with or without the protective film in a solution including the dyeing substance(s) (in this case indicated with the term: disperse dyes), or by incorporating the dyeing substance(s) (in this case indicated with the term: soluble dyes) in the mass of the material which constitutes the optical part during its manufacture.

Preferably, the optical part incorporates a combination of disperse dyes and/or soluble dyes.

In a preferred embodiment, the optical part has a grey color and incorporates a combination of disperse dyes selected among Disperse Violet 1, Disperse Blue 7 and Disperse Yellow 3.

Among the latter, Disperse Violet 1 has a particular importance in order to obtain the desired color of the optical element. The use of Disperse Violet 1, in fact, allows to absorb the wavelengths comprised between 540 and 600 nm enhancing the perception of the remaining colors, i.e. blue-green and red-orange.

Thanks to this preferred combination of dyeing substances, it is advantageously possible to obtain a curve of the factor of spectral transmittance which fully complies with the requirements needed to achieve the desired enhancement of the chromatic contrast perception.

In another preferred embodiment, the optical part incorporates a combination of disperse dyes similar to the preceding one with the addition of a suitable quantity of Disperse Red 15 adapted to modify the color of the optical part (from grey to brown), while maintaining at adequate values the value of the factor of spectral transmittance at the relative maximum located between the wavelengths of 400 and 510 nm.

In this way, it is advantageously possible to obtain a color change of the optical part, for example from grey to brown, without altering in a substantial way the curve of the factor of spectral transmittance in the wavelength range of interest for achieving the desired enhancement of the chromatic contrast perception.

In a preferred embodiment and in order to avoid that the harmful ultraviolet radiations may reach the eye, the optical part further comprises at least one ultraviolet absorber, such as one of those available on the market and suitable for the purpose.

According to the invention, the optical element may be either a semi-finished product from which it is possible to obtain by shaping and, possibly, by beveling an ocular of any shape, or a finished product, such as for instance an ocular for eye protection devices.

As said above, within the framework of the present description and of the following claims, the term: ocular, is used herein to indicate an element suitable to allow vision, such as for instance a lens for eyeglasses, a visor, a protection mask or a portable screen, according to the provisions of European Standard CEN EN 165.

If the optical element is a finished product, it may be obtained from a respective semi-finished product by means of shaping and possibly by beveling operations known per se, or by injection molding.

According to a further aspect, the invention also relates to an eye protection device adapted to optimize the perception capacity of the chromatic contrast and comprising an optical element as described hereinabove.

According to a first embodiment, such an eye protection device is essentially constituted by eyeglasses comprising a supporting frame wherein a couple of lens-shaped oculars are mounted.

The lenses may be ophthalmic, i.e. capable of correcting sight defects, or devoid of any corrective capacity.

According to a second embodiment, such an eye protection device comprises an ocular in the form of a one-piece visor or unitary lens having a suitable size and shape.

According to an additional aspect thereof, the present invention is also directed toward a method for manufacturing an optical element comprising a dyed optical part as is defined in attached claim 27.

This method comprises in particular the steps of:

forming an optical element comprising an optical part by means of a mass of transparent plastics material;

dyeing said optical part so as to obtain a curve of the factor of spectral transmittance in a wavelength range comprised between 400 and 700 nm comprising:
i) at least one relative maximum at a wavelength comprised between 400 and 510 nm, and
ii) at least one relative minimum at a wavelength comprised between 510 and 625 nm,
   wherein the ratio between the value of the factor of spectral transmittance at said at least one relative maximum and the value of the factor of spectral transmittance at said at least one relative minimum is of at least 1.3, and
   wherein the ratio between the value of the factor of spectral transmittance at a wavelength of 700 nm and the value of the factor of spectral transmittance at said at least one relative minimum is of at least 3.0.

In a preferred embodiment, the dyeing step of the optical part may be carried out by incorporating into the transparent plastics material at least one suitable dyeing substance, for example preferably comprising azobenzene or anthraquinone chromophore groups.

Advantageously, this incorporation step may be carried out by means of thermal transfer techniques in liquid phase known per se in the art.

Preferably, the dyeing step of the optical part by means of the aforementioned techniques may be carried out by dipping the optical part of the optical element, for instance made of a suitable plastics material such as CR39®, in an aqueous solution heated at a suitable temperature and including suitable dyeing substance(s) which is(are) incorporated within the polymer matrix substantially by means of a diffusion mechanism.

Preferably, the aqueous solution is heated at a temperature comprised between 70° C. and 97° C., while the dipping time of the optical part is comprised between 20 and 120 minutes.

In a preferred embodiment, the dyeing step of the optical part is carried out by using a combination of disperse dyes selected among Disperse Violet 1, Disperse Blue 7 and Disperse Yellow 3 in quantities adapted to obtain the desired color of the optical part.

In an alternative embodiment, the dyeing step of the optical part is carried out by using a combination of disperse dyes further comprising Disperse Red 15 in a quantity adapted to obtain the desired color of the optical part.

According to an additional aspect thereof, the invention also relates to a method for manufacturing an optical element comprising a dyed optical part as is defined in attached claim 32.

This method comprises in particular the steps of:

dyeing a mass of transparent plastics material by means of at least one soluble dyeing substance;

forming an optical element comprising an optical part by means of said mass of dyed transparent plastics material;

wherein said dyeing step of the mass of transparent plastics material is carried out in such a way that said optical part exhibits a curve of the factor of spectral transmittance in a wavelength range comprised between 400 and 700 nm comprising:

i) at least one relative maximum at a wavelength comprised between 400 and 510 nm, and
ii) at least one relative minimum at a wavelength comprised between 510 and 625 mm,
   wherein the ratio between the value of the factor of spectral transmittance at said at least one relative maximum and the value of the factor of spectral transmittance at said at least one relative minimum is of at least 1.3, and
   wherein the ratio between the value of the factor of spectral transmittance at a wavelength of 700 nm and the value of the factor of spectral transmittance at said at least one relative minimum is of at least 3.0.

According to this aspect of the invention, therefore, the optical element is manufactured by firstly incorporating in the transparent plastics material at least one soluble dyeing substance adapted to impart the desired spectral characteristics to the optical part and then by forming an optical element (sheet, visor, etc.) having a predetermined shape and thickness, for example by extrusion or molding.

Preferably, the dyeing step of the mass of transparent plastics material is carried out by incorporating into the plastics material at least one soluble dyeing substance, for example preferably comprising azobenzene or anthraquinone chromophore groups.

In a preferred embodiment, the dyeing step of the mass of transparent plastics material is carried out by incorporating into the plastics material a combination of soluble dyes selected among the dyes indicated by the Color Index as “Solvent Dyes” such as for example Solvent Violet 13, Solvent Blue 128 and Solvent Yellow 114.

In another embodiment, the dyeing step of the mass of transparent plastics material is carried out by incorporating into the plastics material a combination of soluble dyeing substances further comprising for example Solvent Red 52.

Also in this case, the soluble dyeing substances are incorporated into the plastics material in quantities suitable to achieve the desired color of the optical part.

Additional objects, features and advantages of the invention will become more readily apparent from the following non-limitative examples thereof, given hereinbelow for illustration and not for limitation purposes with reference to the accompanying drawing figures. It is to be understood that such figures are shown solely for the purpose of exemplification and do not define the limits of the invention which will be set forth in the appended claims.

### BRIEF DESCRIPTION OF THE DRAWINGS

The following drawing figures—provided only for illustration purposes—show as many curves of the factor of spectral transmittance within a system of Cartesian coordinates having in the abscissa the wavelengths and in the ordinate the factor of spectral transmittance T of respective lens-shaped optical elements according to the prior art and according to the invention:

FIG. 1 shows the curve of the factor of spectral transmittance of a grey lens according to the prior art;

FIG. 2 shows the curve of the factor of spectral transmittance of a brown lens according to the prior art;

FIG. 3 shows the curve of the factor of spectral transmittance of a green lens according to the prior art;

FIG. 4 shows the curve of the factor of spectral transmittance of a grey lens according to prior art the present invention;

FIG. 5 shows the curve of the factor of spectral transmittance of a brown lens according to the present invention;

FIG. 6 shows the curve of the photopic sensitivity of the human eye;

FIG. 7 shows for the sake of comparison the curve of the photopic sensitivity of the human eye overlapped to the curve of the factor of spectral transmittance of the lens of FIG. 4.

### DETAILED DESCRIPTION OF THE PRESENTLY PREFERRED EMBODIMENTS OF THE PRESENT INVENTION

In the examples given hereinbelow, the various compositions will be defined by indicating the parts by weight of each component unless otherwise specified.

In these examples, lens-shaped optical elements were dyed with dyeing substances belonging to the classes of azo- or anthraquinone dyes described in the Color Index as Disperse Dyes and Solvent Dyes.

The used dyeing substances were a main violet dye (Disperse Violet 1) corrected with blue (Disperse Blue 7), yellow (Disperse Yellow 3) and red (Disperse Red 15) to obtain the various color shades comprised between grey and brown.

### EXAMPLE 1

### Prior Art

A lens made of diethylenglycol-bis-allyl-carbonate (CR39®) was obtained by polymerizing in a glass mold a solution of CR39® monomer including 3% of cross-linking catalyst (diisopropyl peroxy dicarbonate) and 0.3% of UV absorber Uvinul® 3049 (BASF). The thermal polymerization cycle lasted 20 hours at temperatures between 40° and 80° C.

The lens thus obtained was dyed by means of a thermal transfer technique in liquid phase.

To this end, a dyeing bath constituted by an aqueous solution comprising: 0.2% Disperse Blue 7, 0.1% Disperse Red 15 and 0.03% Disperse Yellow 3, was prepared.

The lens was then dyed by immersion for 20 minutes in this bath maintained at a temperature of 90° C.

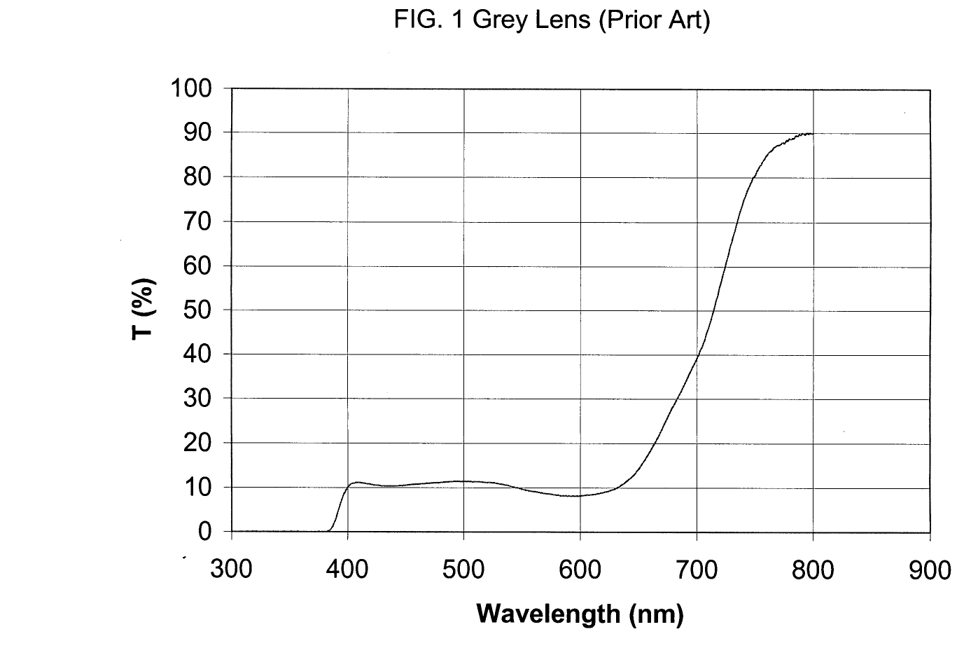

The curve of the factor of spectral transmittance obtained is the curve of a grey lens and is shown in FIG. 1.

### EXAMPLE 2

### Prior Art

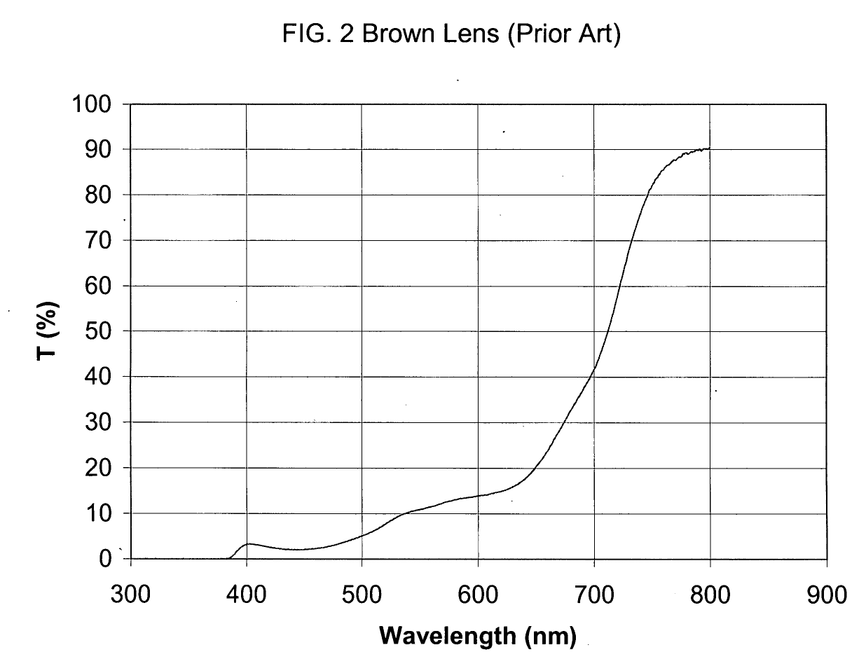

The same procedure of Example 1 was followed except for the fact that the dyeing bath was in this case constituted by an aqueous solution comprising: 0.2% Disperse Blue 7, 0.15% Disperse Red 15 and 0.05% Disperse Yellow 3. The curve of the factor of spectral transmittance obtained is the curve of a brown lens and is shown in FIG. 2.

### EXAMPLE 3

### Prior Art

The same procedure of Example 1 was followed except for the fact that the dyeing bath was in this case constituted by an aqueous solution comprising: 0.2% Disperse Blue 7, 0.08% Disperse Red 15 and 0.1% Disperse Yellow 3.

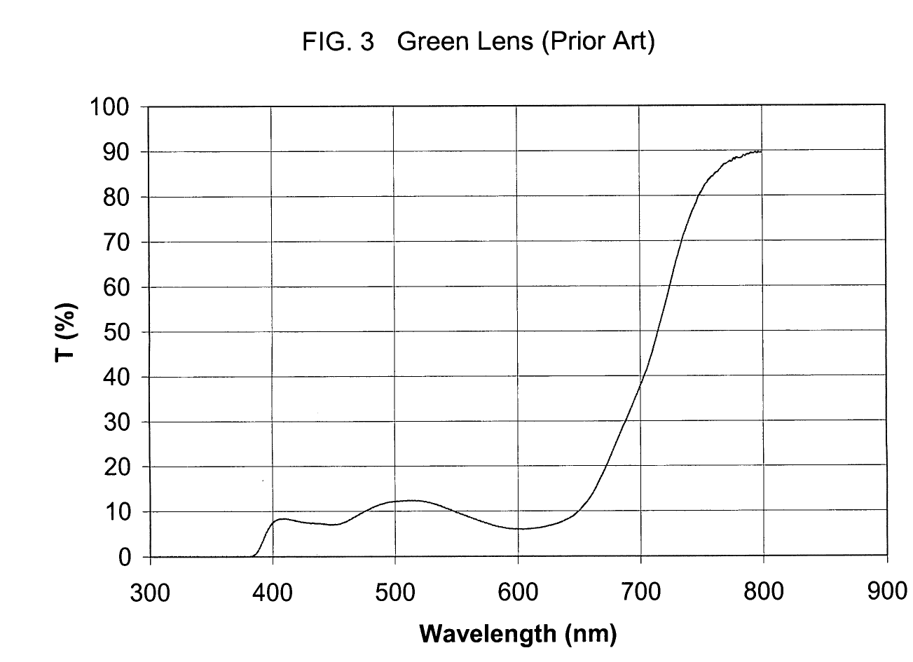

The curve of the factor of spectral transmittance obtained is the curve of a green lens and is shown in FIG. 3.

### EXAMPLE 4

### Invention

The same procedure of Example 1 was followed except for the fact that the dyeing bath was in this case constituted by an aqueous solution comprising 0.2% Disperse Violet 1, 0.1% Disperse Blue 7 and 0.02% Disperse Yellow 3.

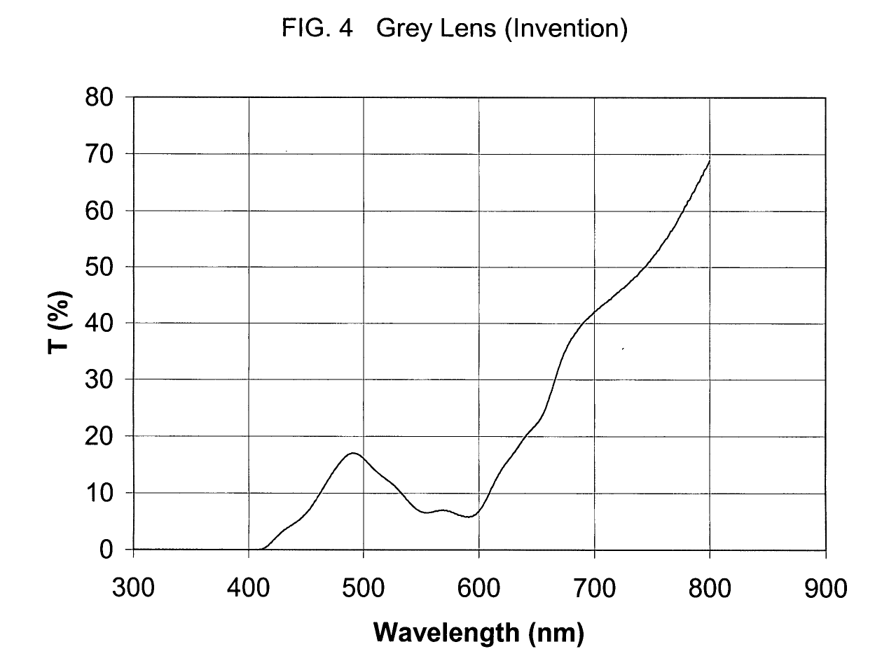

The curve of the factor of spectral transmittance obtained is the curve of a grey lens and is shown in FIG. 4.

### EXAMPLE 5

### Invention

The same procedure of Example 1 was followed except for the fact that the dyeing bath was in this case constituted by an aqueous solution comprising 0.2% Disperse Violet 1, 0.1% Disperse Blue 7, 0.02% Disperse Yellow 3 and 0.01% Disperse Red 15.

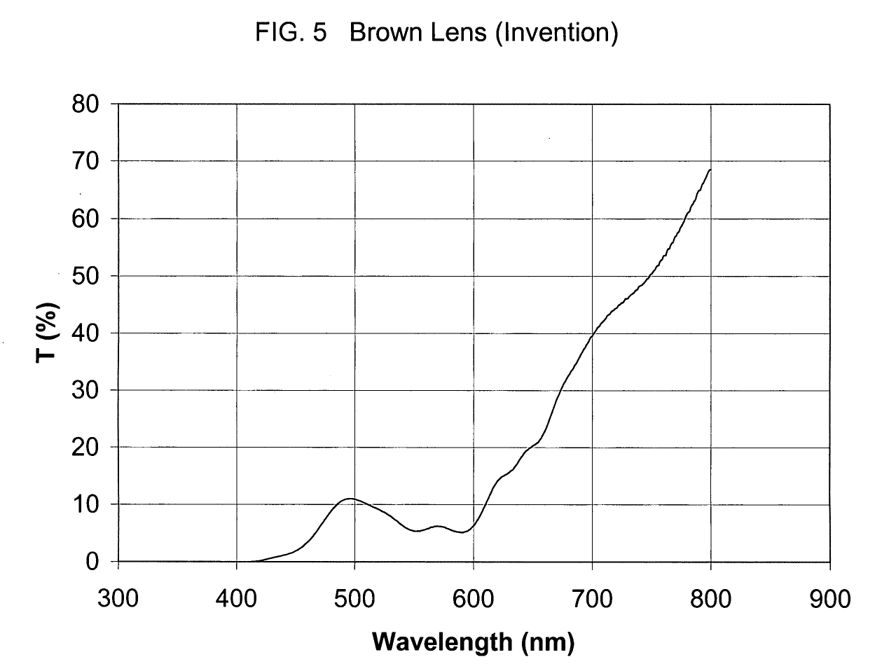

The curve of the factor of spectral transmittance obtained is the curve of a brown lens and is shown in FIG. 5.

### EXAMPLE 6

### Invention

A NXT® transparent polyurethane resin (Intercast Europe) was obtained, by means of methods known per se for example those described in U.S. Pat. No. 6,127,505 the content of which is herein incorporated by reference, by adding to a base prepolymer—obtained from methylenebis(cyclohexyl isocyanate) and a polyester glycol prepared from adipic acid and 1,6-hexanediol (equivalent weight: 500, Ruco Polymer Corporation), the following soluble dyes: 0.03% Solvent Violet 13, 0.015% Solvent Blue 128, 0.010% Solvent Yellow 114 and by adding 0.3% of a UV absorber (Uvinul 3049, BASF).

The base prepolymer of NXT was mixed with these substances so as to obtain a homogeneously dyed and perfectly transparent mixture and was then injected together with a cross-linking agent (diethylene toluenediamine or DETDA, which is commercially available under the trade name of ETHACURE® 100 (Albemarle Corporation)) through a mixing head into a suitable mold and polymerized for 10 hours at 120° C.

A grey lens was obtained having a curve of the factor of spectral transmittance substantially identical to the curve of Example 4 (see FIG. 4).

### EXAMPLE 7

### Invention

The same procedure of Example 6 was followed except for the fact that the transparent resin used was an allyl resin commercially available under the trade name of RAV 7 MC® (Great Lakes) and for the fact that the dyeing step of the mass of transparent plastics material was carried out by incorporating into the plastics material a combination of soluble dyeing substances further comprising 0.01% of Solvent Red 52. In this case, the dyed resin was then mixed with 2% of a cross-linking agent (perketal catalyst), injected in suitable molds and polymerized for 20 hours between 60° and 90° C.

A brown lens was obtained having a curve of the factor of spectral transmittance substantially identical to the curve of Example 5 (see FIG. 5).

### EXAMPLE 8

### Evaluation of the Attenuation Coefficient

In order to evaluate the attenuation coefficient (Q Quotient) of the lenses according to the prior art of Examples 1 and 2 and of the lenses according to the invention of Examples 4, 5, 6 and 7, a series of tests were carried out according to European Standard EN 1836:1997.

The test results are shown in the following Table 2.

TABLE 2
Relative visibility of traffic lights and colors (Q Quotients)

| | Example | | | | |
|---|---|---|---|---|---|
| | FST (%) | Red | Yellow | Green | Blue |
| 1 - Grey prior art | 15 | 1 | 1 | 1 | 1 |
| 4 - Grey invention | 15 | 1.2 | 1 | 1 | 1.4 |
| (Ex. 4 and 6) | | | | | |
| 2 - Brown prior art | 15 | 1.2 | 1 | 1 | 1 |
| 5 - Brown invention | 15 | 1.4 | 1.1 | 1 | 1.2 |
| (Ex. 5 and 7) | | | | | |

FST=Factor of Spectral Transmittance, intended as the ratio of the luminous flux let through by the optical element in a wavelength range (λ) of from 380 and 780 nm, to the incident luminous flux in a wavelength range (λ) of from 380 and 780 nm, according to European Standard CEN EN 165 point 2.64.

Red traffic light measured between 590 and 640 nm

Yellow traffic light measured between 550 and 610 nm

Green traffic light measured between 500 and 550 nm

Blue signal light measured between 470 and 530 nm

As it may be inferred from the preceding Table, the lenses manufactured according to the present invention enhance the chromatic contrast as is demonstrated by the values of the attenuation coefficients (Q quotients) for each of the four reference colors Red, Yellow, Blue and Green considered by the European Standard EN 1836:1997.

As discussed above, if the Q quotient of a particular color viewed through the lens is higher than 1, it means that the particular color is more visible than the sunlight when both are viewed through the same lens.

By comparing the Q quotients of the prior art grey and brown lenses (Examples 1 and 2) with the Q quotients of the lenses according to the invention (Examples 4, 5, 6 and 7) it is evident that the chromatic combination red-orange and blue-green is enhanced.

As may be noted by examining the data reported hereinabove and the curves of the factor of spectral transmittance illustrated in FIGS. 1-5, it is evident that the optical elements of the present invention have substantially non-linear curves, i.e. not having substantially linear portions or portions which may be considered substantially linear and, in contrast to what happens for the optical elements of the prior art of Examples 1-3, show:
i) at least one relative maximum at a wavelength comprised between 400 and 510 nm (16.5% at 485 nm for Examples 4 and 6, 11% at 495 nm for Examples 5 and 7);
ii) at least one relative minimum at a wavelength comprised between 510 and 625 nm (5.8% at 589 nm for Examples 4 and 6, and 5.2% at 586 nm for Examples 5 and 7);
iii) a ratio between the value of the factor of spectral transmittance at said at least one relative maximum and the value of the factor of spectral transmittance at said at least one relative minimum of at least 1.3 (2.8 for Examples 4 and 6, and 2.1 for Examples 5 and 7), and
iv) a ratio between the value of the factor of spectral transmittance at a wavelength of 700 nm and the value of the factor of spectral transmittance at said at least one relative minimum of at least 3.0 (7.2 for Examples 4 and 6, and 7.7 for Examples 5 and 7).

Preferably, furthermore, the optical elements of Examples 4, 5, 6 and 7 also have a value of the factor of spectral transmittance at a wavelength of 700 nm equal to at least 30% and more specifically of 42% (Examples 4 and 6) and of 40% (Examples 5 and 7).

Preferably, the curves of the factor of spectral transmittance of the optical elements according to the present invention and illustrated in FIGS. 4 and 5 have an increasing value of the factor of spectral transmittance in the wavelength range comprised between 625 and 700 nm so as to optimize the effect of an increased perception of the chromatic contrast by increasing the light transmitted in the wavelength range in which the human eye is less sensitive (orange-red).

Advantageously, the curves of the factor of spectral transmittance of the optical elements according to the present invention and illustrated in FIGS. 4 and 5 have a substantially null value up to 410 nm, i.e. in the transmission zone of UV and blue-violet light, which may be harmful to the crystalline and retina.

This effect is obtained by adding a UV absorber (such as UVINUL® 3049 available from BAYER) to the transparent plastics material used to manufacture the optical element and by using a Yellow dye.

In FIGS. 4 and 5, the curve of the factor of spectral transmittance increases from 410 nm and reaches a relative maximum at a wavelength lower than 500 nm, whereupon the curve starts to decrease reaching a relative minimum between 540 and 600 nm.

The curve then increases again preferably without further relative maxima or minima.

By virtue of the characteristics of the eye-brain receptive system illustrated above and of its selective chromatic adaptation, a viewer looking through the lenses of Examples 4, 5, 6 and 7 will have an enhanced vision of the blue-green colors below 540 nm and of the red-orange colors above 610 nm, while the green-yellow colors (range 540-610 nm), even if strongly attenuated, will still remain clearly visible thanks to the high sensitivity of the human eye in this wavelength range.

In this way and in accordance with the invention, the desired technical effect is achieved of enhancing visual acuity by increasing the sensitivity to the red and blue colors, while complying at the same time to the stringent recognition requirements of traffic lights and road signals indicated by the international standards.

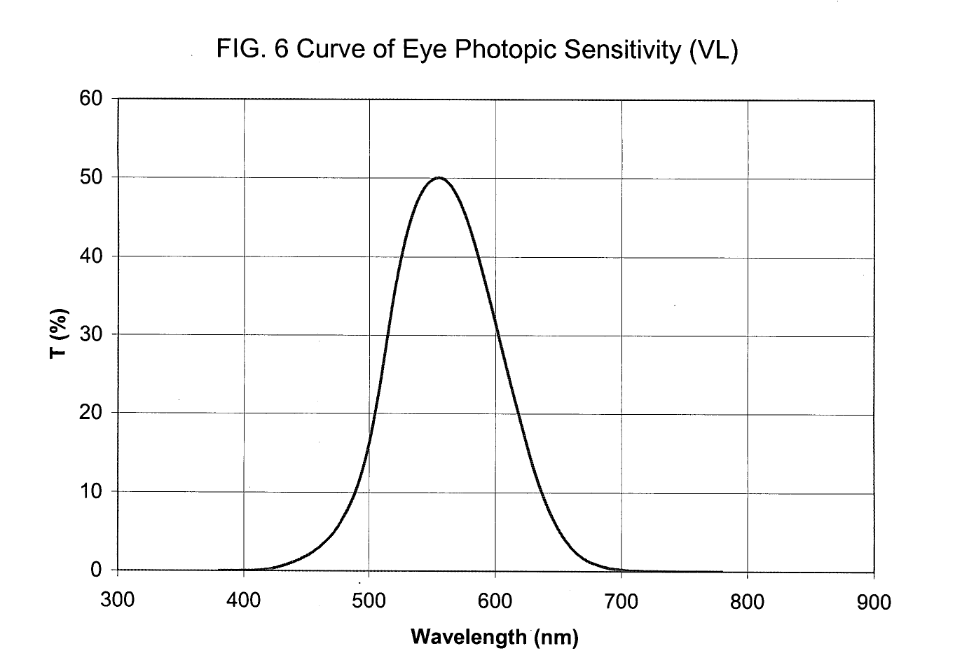

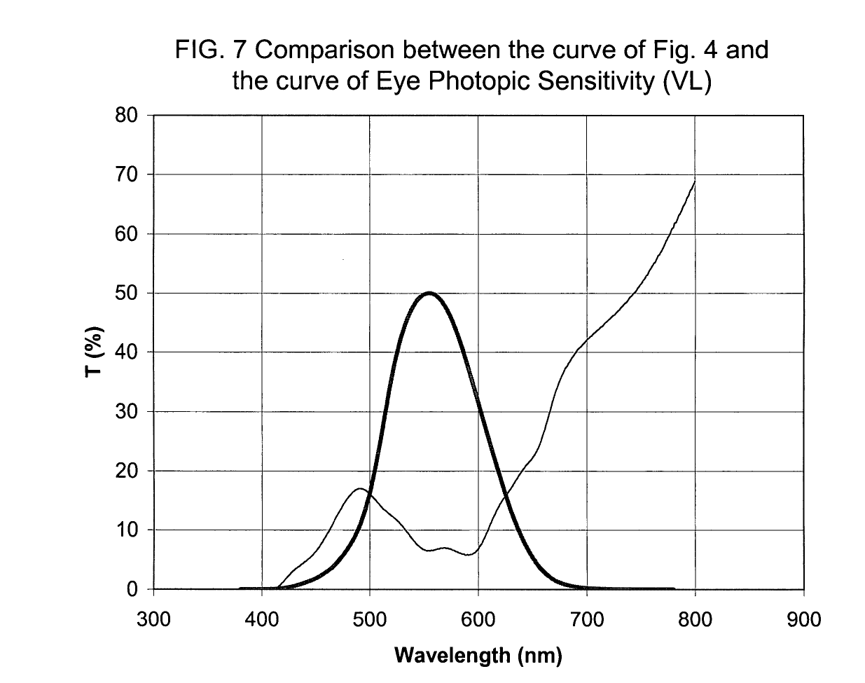

In order to further illustrate the chromatic compensation mechanism underlying the present invention, reference will now be made to the curves shown in FIGS. 6 and 7.

FIG. 6 shows in particular the photopic sensitivity curve of the human eye which reaches a maximum sensitivity around 550-555 nm.

As illustrated above, the invention advantageously exploits the high sensitivity of the human eye to radiations having a wavelength around 550 nm, so that a reduction of the amount of light within an ample range about this wavelength will not significantly reduce the visibility of the corresponding colors (green-yellow) since the eye-brain receptive system is capable of adapting itself to this reduced energy.

Conversely, the increase of the factor of spectral transmittance in the wavelength range comprised between 400 and 510 nm and between 625 and 700 nm, wherein the eye is less sensitive, is capable of amplifying the corresponding colors (blue-green and orange-red) since the corresponding luminous energy is higher than the energy of the wavelength range in which the eye sensitivity is at its maximum.

An example of this effect is graphically shown in FIG. 7 which shows an overlap of the transmission curve of the lenses of Examples 4 and 6 and the photopic sensitivity curve of the human eye: as is evident, the lenses of these examples reduce the factor of spectral transmittance in the wavelength range comprised between 500 and 625 nm and preferably between 540 and 600 nm in which the sensitivity of the human eye is higher. Because the transmission in the range 500-625 nm is reduced with respect to the transmission in the other ranges of the visible spectrum (400-500) and (625-800) in which the eye is not as sensitive, the eye sensitivity in these other ranges is increased.

The visibility enhancement of blue-green and red-orange is important for vehicle drivers because red and blue are often used in road signals, particularly the red color which is used for warning signals and emergency lights. The recognition of yellow and green is left substantially unaltered in view of the higher eye sensitivity to these colors. These lenses, furthermore, absorb all the UV radiations and part of the adjacent violet radiation.

Finally, the invention advantageously allows to manufacture optical elements capable to fulfill the color recognition and traffic light recognition requirements provided for not only by European Standard EN 1836:1997, but also by US Standard ANSI Z80.3 for non prescription sunglasses.

Clearly, a man skilled in the art can bring modifications and variants to the invention described above, in order to satisfy contingent and specific application requirements, which variants and modifications are in any case all covered by the scope of protection as defined by the following claims.

1. Optical element comprising an optical part dyed so as to have a curve of the factor of spectral transmittance in a wavelength range comprised between 400 and 700 nm comprising:
i) at least one relative maximum at a wavelength comprised between 400 and 510 mm, and
ii) at least one relative minimum at a wavelength comprised between 510 and 625 nm,
wherein the ratio between the value of the factor of spectral transmittance at said at least one relative maximum and the value of the factor of spectral transmittance at said at least one relative minimum is of at least 1.3, and
wherein the ratio between the value of the factor of spectral transmittance at a wavelength of 700 nm and the value of the factor of spectral transmittance at said at least one relative minimum is of at least 3.0.

2. Optical element according to claim 1, wherein the curve of the factor of spectral transmittance of the optical part comprises at least one relative maximum at a wavelength comprised between 440 and 500 nm.

3. Optical element according to claim 1, wherein the curve of the factor of spectral transmittance of the optical part comprises at least one relative minimum at a wavelength comprised between 540 and 610 nm.

4. Optical element according to claim 3, wherein the curve of the factor of spectral transmittance of the optical part comprises at least one relative minimum at a wavelength comprised between 560 and 600 nm.

5. Optical element according to claim 1, wherein the value of the factor of spectral transmittance at said at least one relative maximum is comprised between 4% and 40%.

6. Optical element according to claim 1, wherein the value of the factor of spectral transmittance at said at least one relative minimum is comprised between 2% and 40%.

7. Optical element according to claim 1, wherein the ratio between the value of the factor of spectral transmittance at said at least one relative maximum and the value of the factor of spectral transmittance at said at least one relative minimum is comprised between 1.3 and 15.

8. Optical element according to claim 1, wherein the ratio between the value of the factor of spectral transmittance at a wavelength of 700 nm and the value of the factor of spectral transmittance at said at least one relative minimum is comprised between 3.0 and 20.

9. Optical element according to claim 1, wherein in a wavelength range comprised between 400 and 625 nm the difference between the value of the factor of spectral transmittance at said at least one relative maximum and the value of the factor of spectral transmittance at said at least one relative minimum is comprised between 2% and 50%.

10. Optical element according to claim 9, wherein the difference between the value of the factor of spectral transmittance at said at least one relative maximum and the value of the factor of spectral transmittance at said at least one relative minimum is comprised between 5% and 30%.

11. Optical element according to claim 1, wherein the value of the factor of spectral transmittance at a wavelength of 700 nm is of at least 20%.

12. Optical element according to claim 1, wherein the factor of spectral transmittance in a wavelength range comprised between 625 and 700 nm has an increasing value as the wavelength increases.

13. Optical element according to claim 1, wherein the value of the factor of spectral transmittance in a wavelength range comprised between 480 and 510 nm is of at least 10%.

14. Optical element according to claim 1, wherein the value of the factor of spectral transmittance at a wavelength equal to or lower than 400 nm is substantially equal to 0%.

15. Optical element according to claim 1, characterized by the fact of being essentially constituted by a substrate made of a transparent plastics material.

16. Optical element according to claim 15, characterized in that said substrate made of transparent plastics material is selected from the group comprising: polymethyl methacrylate, polyol-allyl-carbonates, aromatic polycarbonates, polystyrene, cellulose esters, polyacrylates, polyalkylacrylates, polyurethanes, saturated and unsaturated polyesters, transparent polyamides, copolymers and mixtures thereof.

17. Optical element according to claim 1, wherein the optical part comprises at least one dyeing substance adapter to filter the visible light.

18. Optical element according to claim 17, wherein the optical part comprises a combination of Disperse Dyes and/or Solvent Dyes.

19. Optical element according to claim 18, wherein the optical part comprises a combination of Disperse Dyes selected among Disperse Violet 1, Disperse Blue 7 and Disperse Yellow 3.

20. Optical element according to claim 19, wherein the optical part comprises a combination of Disperse Dyes further comprising Disperse Red 15.

21. Optical element according to claim 1, wherein the optical part further comprises at least one ultraviolet absorber.

22. Optical element according to claim 1, in the form of semi-finished product for the manufacture of oculars for eyeglasses.

23. Optical element according to claim 1, in the form of an ocular.

24. Optical element according to claim 23, wherein said ocular is a lens for eyeglasses.

25. Optical element according to claim 23, wherein said ocular is a visor.

26. An eye protection device comprising an optical element according to claim 23.

27. Method for manufacturing an optical element comprising a dyed optical part, comprising the steps of:
forming an optical element comprising an optical part by means of a mass of transparent plastics material;
dyeing said optical part so as to obtain a curve of the factor of spectral transmittance in a wavelength range comprised between 400 and 700 nm comprising:
i) at least one relative maximum at a wavelength comprised between 400 and 510 nm, and
ii) at least one relative minimum at a wavelength comprised between 510 and 625 nm,
wherein the ratio between the value of the factor of spectral transmittance at said at least one relative maximum and the value of the factor of spectral transmittance at said at least one relative minimum is of at least 1.3, and
wherein the ratio between the value of the factor of spectral transmittance at a wavelength of 700 nm and the value of the factor of spectral transmittance at said at least one relative minimum is of at least 3.0.

28. Method according to claim 27, wherein said dyeing step of the optical part is carried out by introducing into the transparent plastics material at least one dyeing substance.

29. Method according to claim 28, wherein said dyeing step of the optical part is carried out by dipping the optical part in an aqueous solution comprising at least one disperse dyeing substance.

30. Method according to anyone of claims 28 or 29, wherein said dyeing step of the optical part is carried out by using a combination of Disperse Dyes selected among Disperse Violet 1, Disperse Blue 7 and Disperse Yellow 3.

31. Method according to claim 30, wherein said dyeing step of the optical part is carried out by using a combination of Disperse Dyes further comprising Disperse Red 15.

32. A method for manufacturing an optical element comprising a dyed optical part, comprising the steps of:
dyeing a mass of transparent plastics material by means of at least one soluble dyeing substance;
forming an optical element comprising an optical part by means of said mass of dyed transparent plastics material;
wherein said dyeing step of the mass of transparent plastics material is carried out in such a way that said optical part exhibits a curve of the factor of spectral transmittance in a wavelength range comprised between 400 and 700 nm comprising:
i) at least one relative maximum at a wavelength comprised between 400 and 510 nm, and
ii) at least one relative minimum at a wavelength comprised between 510 and 625 nm,
wherein the ratio between the value of the factor of spectral transmittance at said at least one relative maximum and the value of the factor of spectral transmittance at said at least one relative minimum is of at least 1.3, and
wherein the ratio between the value of the factor of spectral transmittance at a wavelength of 700 nm and the value of the factor of spectral transmittance at said at least one relative minimum is of at least 3.0.

33. Method according to claim 32, wherein said dyeing step of the mass of transparent plastics material is carried out by incorporating into the plastics material at least one soluble dyeing substance.

34. Method according to claim 33, wherein said dyeing step of the mass of transparent plastics material is carried out by incorporating into the plastics material a combination of soluble dyeing substances selected among Solvent Violet 13, Solvent Blue 128 and Solvent Yellow 114.

35. Method according to claim 34, wherein said dyeing step of the mass of transparent plastics material is carried out by incorporating into the plastics material a combination of soluble dyeing substances further comprising Solvent Red 52.
